(19) United States
(12) Patent Application Publication
(10) Pub. No.: US 2007/0285429 A1
(43) Pub. Date: Dec. 13, 2007

(54) System for Generating a Distributed Image Processing Application

(75) Inventors: Raoul Florent, Ville D'Avray (FR); Claude Mequio, Villejuif (FR)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/596,488

(22) PCT Filed: Dec. 17, 2004
(86) PCT No.: PCT/IB04/04226

§ 371 Date: May 2, 2007

(30) Foreign Application Priority Data
Dec. 22, 2003 (EP) 03300280.9

(51) Int. Cl. G06T 1/20

(52) U.S. Cl. 345/506

(57) ABSTRACT

The present invention relates to a system for distributing an image processing application over a set of processors. Said system comprises reading means for reading an input document, compiling means for detecting inconsistencies in said input document, and building means for building an executable code from said compiled document for programming said set of processors. The input document specifies modules for applying entire or steps of image processing functions to an input image. Such a module comprises input/output ports for receiving or transmitting image strips via input/output links. Said input/output ports are specified by a geometry and a law, said geometry defining a subdivision of said input image into a set of image strips and said law defining a subset of said set of image strips that is to pass through said input/output port. A module is attached to one processor of said set of processors, which runs the specified image processing function.

### FIELD OF THE INVENTION

The present invention relates to a system for distributing an image processing application over a set of processors. The present invention further relates to a method implemented in such a system. The present invention also relates to an input document to be read by such a system. The present invention finally relates to an executable code for programming said image processing application over said set of processors.

The present invention finds its application in particular in the domain of medical image processing.

### BACKGROUND OF THE INVENTION

New real-time medical applications now require the use of complex distributed processor systems. Such systems are made of commercial off-the-shelf multiprocessor boards, in which the various processors are linked by an interconnect fabric transporting the data to be processed.

Programming such an application poses a challenge to an application developer, who has to make a great effort in getting a first version of the application to compile and run. This is due to the complexity of having many processes or tasks that must run concurrently and exchange data. Therefore, there has been a need for a tool to help produce a multiprocessor executable code that is correct.

The main requirements for such a tool are to enhance performance by reducing development and debug times and flexibility by allowing an easy and quick upgrade of the application specification.

The international patent application WO02/063559 applied by Koninklijke Philips Electronics N. V. and published on Aug. 15, 2002 discloses a system for distributing a medical image processing application over a set of processors, which is based on three principles:
a synchronous data flow model in which the distributed application is represented by a directed graph, comprising modules which represent functions, and directed arcs which represent paths over which data flow. Theses paths are also called connections or links. In a synchronous data flow model, a number of data packets produced or consumed by each module at each function invocation is specified a priori,
the input image is divided into a number of image strips. An image strip is a horizontal band of consecutive pixels in the order of input. An advantage of such a division is to fulfill the low-latency constraint. As a matter of fact, the latency is reduced to the time required for processing one image strip instead of one entire image,
Several connection types are introduced, which are:
   Broadcasting, which corresponds to sending a same image strip over several data paths,
   Scattering, which corresponds to sending non-consecutive strips over a data path,
   Gathering, which corresponds to receiving contributions from several data paths, each bringing image strips belonging to a same input image.
The notion of scatter/gather (data partitioning) renders it possible to distribute the execution of a function over several modules, each module being invoked for only one part of the image strips. Such a notion has to be distinguished from the notion of pipelining (task partitioning), which distributes the execution of a function over several consecutive modules, each module executing one or several steps of the function.

A drawback of such a system is that it is not able to determine unambiguously which image strips are flowing on which connection. Therefore, complex applications like those involved in the domain of medical image processing, which combine pipelining and scattering/gathering cannot be properly and safely designed.

### SUMMARY OF THE INVENTION

The object of the invention is to provide a tool for developing complex distributed applications in an efficient and flexible way, which unambiguously determines the path followed by an image strip.

This is achieved by a system for distributing an image processing application over a set of processors, said system comprising:
reading means for reading an input document for describing a distribution of an image processing application over said set of processors, said input document comprising at least a module describing at least part of an image processing function to be applied to at least one input image by a processor of said set of processors, said input image being subdivided into image strips, said module comprising at least one input port for receiving image strips to be processed by said module via at least one input link and/or at least one output port for transmitting processed image strips over at least one output link, said input/output port being specified by a geometry and a law, said geometry defining a division of said input image into a set of image strips and said law defining a subset of said set of image strips that is to pass through said input/output port,
compiling means for detecting inconsistencies in said input document,
building means for building an executable code from said compiled document for programming said set of processors.

With the invention, the geometry and the law attached to the input/output ports of a module completely specify which image strips are received, processed and transmitted by said module at an iteration. Such a precise specification of the paths followed by the image strips between modules renders it possible to define complex connection schemes without any ambiguity.

Advantageously, the geometry locates an image strip by means of an image strip index, and the law defines said image strip index as a function of an iteration index.

With the invention, the geometry and the law attached to the input/output ports of a module are parametrized by parameters which are relative to a module. Said relative parameters are specified by the input document. Advantageously, the compiling means in accordance with the invention comprises calculating means for converting said relative parameters into absolute parameters with respect to the specified distribution.

With the invention, a module may apply either part of or an entire image processing function. In the first case, said module belongs to a group of modules linked by a pipelining connection.

Another aspect of the invention is that a module may process either some of or all the image strips of the input image. In the first case, said module belongs to a group of modules linked by a scatter-gather connection. The law attached to each input port of the module defines which images strips of the input image are to be processed by the module.

In a first embodiment of the invention, a sub-group of consecutive image strips is sent to the module. An advantage of this solution is that it is simple. The latency of the image processing application amounts to the delay for processing the largest sub-group of image strips.

In a second embodiment of the invention, the image strips are distributed periodically between the modules of the group of modules forming the scatter/gather connection. An advantage of this solution is that it reduces the latency of the image processing application to the delay of processing one image strip.

It should be noted that the system in accordance with the invention advantageously renders it possible to combine pipelining and scatter/gather connections. In such complex connection schemes, a module may apply part of a function to part of the image strips defined by a geometry within an input image.

These and other aspects of the invention will be apparent from and will be elucidated with reference to the embodiments described hereinafter.

### BRIEF DESCRIPTION OF THE DRAWINGS

The present invention will now be described in more detail, by way of example, with reference to the accompanying drawings, wherein:

FIG. 1 is a functional drawing of a system for distributing an application over a set of processors in accordance with the invention,

FIGS. 2a and 2b are examples of geometries as specified by an input document in accordance with the invention,

FIG. 3a is an example of a module as specified by an input document in accordance with the invention,

FIG. 3b is a schematic representation of a broadcasting process as specified by an input document in accordance with the invention,

FIG. 4a is a schematic representation of a pipelining process as specified by an input document in accordance with the invention,

FIG. 4b is a schematic representation of a scatter/gather process as specified by an input document in accordance with a first embodiment of the invention,

FIG. 5 is schematic representation of a scatter/gather process as specified by an input document in accordance with a second embodiment of the invention,

FIG. 6 is a schematic representation of an application comprising a cascade of scatter/gather connection schemes as specified by an input document in accordance with the second embodiment of the invention, and

FIG. 7 is a schematic representation of a hardware platform comprising a system in accordance with the invention.

### DETAILED DESCRIPTION OF THE INVENTION

The present invention relates to a system for distributing an image processing application over a set of processors. The present system is particularly adapted to medical image processing, but it may be used more generally for developing any image processing application.

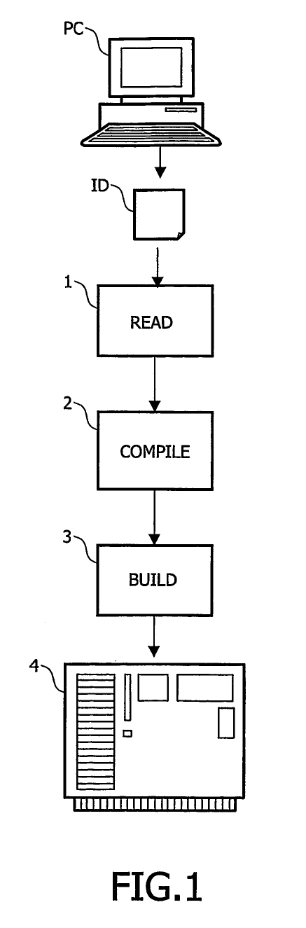

FIG. 1 shows such a system in a functional way. An application developer specifies an image processing application in an input document ID, for example on a personal computer PC. The system in accordance with the invention comprises reading means 1 for reading the input document ID, compiling means 2 for detecting inconsistencies in said input document ID and, building means 3 for building an executable code EC from the compiled input document for programming a set of processors 4.

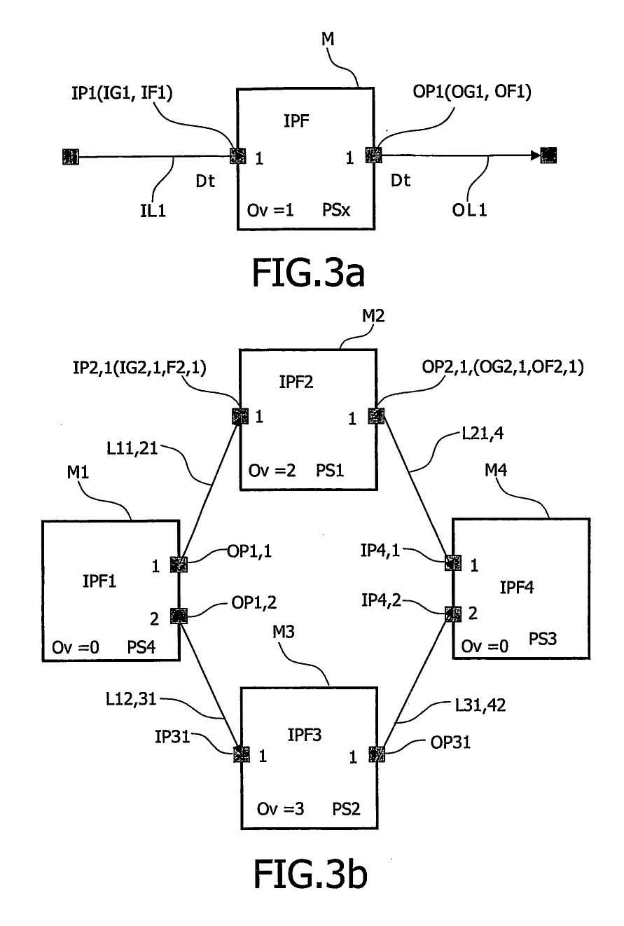

An application comprises a plurality of image processing functions, which are specified by the input document BD. FIGS. 3a to 6 show input documents in accordance with the invention. Said input documents have a graphical format. An advantage of a graphical input document is that it renders possible the use of a visual language for describing the application, which can be both simple and very powerful. It should be noted, however, that textual representations could be used as well.

Referring to FIG. 3a, such an input document comprises at least a module M which applies an image processing function IPF or a step of said image processing function IPF to an input image I. Said module M comprises an indication of a processor PSₓ, on which it will be mapped. Said module M comprises at least an input port IP₁ for receiving the image I via at least an input link IL₁ and/or at least an output port OP₁ for transmitting the processed image PI over at least an output link OL₁. A link IL₁ or OL₁ is a path between an output port and an input port of two distinct modules. It should be noted that some modules, called source modules, have no input port, for example the module which acquires the input image I, and some modules, called sink modules, have no output port, for example the module which displays the processed image at the end of the processing application.

The spatial and temporal localization of the data to be received or transmitted via an input/output port is completely specified by the input document ID in accordance with the invention.

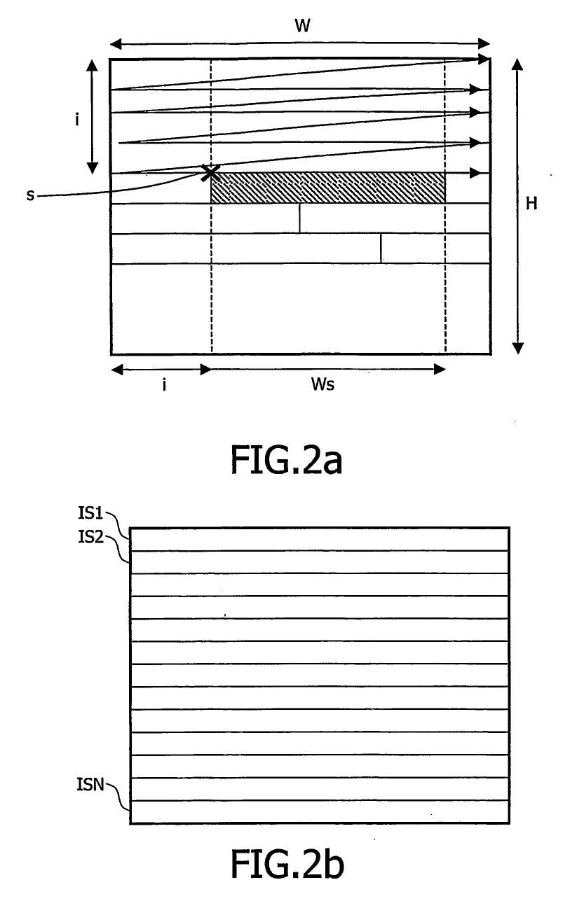

With the invention, the data to be received or transmitted via an input/output port are elements, for example groups of pixels of the input image I. Advantageously, the input image I is divided into a set of image strips. An advantage of such a division is that it reduces the latency of the application from the time for processing an entire image down to the time for processing an image strip. An image strip is a set of consecutive pixels of the input image I in accordance with a module input order or an image scanning order. FIG. 2a shows an example of an image strip. The input image I has a width W and a height H. The image strip is specified, for example, by an index s of its first pixel located in (ij): s=i.w+j and a width Wₛ equal to a number of consecutive pixels forming the image strip.

The input document ID describes at least one subdivision of the input image into a set of image strips IS₁ to IS_{N}. Said subdivision is called a geometry G, which defines the spatial properties of the image strips IS₁ to IS_{N} and gives their locations inside the input image I.

FIG. 2b shows a simple and regular subdivision of the input image I into image strips all having the same width, equal to the width W of the input image, and the same height. It should be noted, however, that the system in accordance with the invention renders it possible to specify any kind of geometry G, from the simplest to the most complex. For example, the image strips do not need to have all the same number of consecutive pixels, and the union of all the image strips defined by the geometry need not necessarily cover the whole input image.

As shown in FIG. 3a, a geometry (IG₁, OG₁) is attached to an input/output port (IP₁, OP₁). Theoretically, two distinct input/output ports of a same image processing application may have different geometries.

An input/output port (IP₁, OP₁) is further specified by a law (IF₁, OF₁). The law defines a subset of the set of image strips defined by the geometry (IG₁, OG₁) that is to pass through the input/output port. Furthermore, with each strip of this subset is associated a unique identifier called a strip index. If N strips are considered, said identifiers, for example, range from 0 to N−1.

Upon an iteration of the process, an image strip of index sₙ specified by the input law IL₁ and the input geometry IG₁ passes through the input port IP₁ and is processed by the module M. For this iteration the index (or indices) of the strip sₙ to be produced from the processing of the input strips is/are determined by the laws of the output ports.

The output port OP has a geometry and a law which have to be conform to the geometry and the law of the input port it is linked to by the output link OL₁. This conformance is checked by the compiling means 2 of the system in accordance with the invention.

FIG. 3b presents an input document ID in accordance with the invention. Said input document is a graphical document which comprises 4 modules M₁, M₂, M₃ and M₄. The module M₁ is a source module which has no input port and two output ports OP_{1,1}, OP_{1,2} and which has, for example, an image acquisition function. The module M₄, which has two input ports IP_{4,1}, IP_{4,2} and no output port, is a sink module having, for example, a display function. The modules M₂ and M₃, which have both an input port IP₂₁, IP₃₁ and and output port OP_{2,1}, OP_{3,1,} may perform any image processing function such as, for example, that of a spatial filter.

If we consider a Module Mₘ, where m is an integer, with an input port IP_{m,p}, where p is an integer, said input port is specified by a geometry IG_{m,p} and a law IFₘₚ. Said geometry IG_{m,p} defines a set of image strips in the input image I. An image strip is defined by an index s, which is, for example, the index of the first pixel of said image strip. The geometry is therefore a function of said index s, which specifies spatial properties of the image strip having the index s. The geometry IG_{m,p} is expressed as a union of geometries g_{m,p}(s) applying to an image strip of index s:

$${IG}_{m , p} = {⋃}_{s ε [ 1 , \overline{{S}_{m , p}} ]} {g}_{m , p} ( s ) ,$$

where S̅_̅{̅m̅,̅p̅}̅ is the total number of image strips defined by the geometry in the input image I.

In each module, an iteration index k is defined as a value of an integer which is initialized at zero when the application starts and which is incremented by one each time the image processing function attached to this module is triggered.

The law IF_{m,p} of said input port IP_{m,p} defines an index of the image strip s to be processed, as a function of an iteration index k, where k is an integer, and other parameters αₘ,βₘ, . . . , ωₘ depending only on the module Mₘ: IF_{m,p}=f(k, αₘ,βₘ, . . . ωₘ)=s.

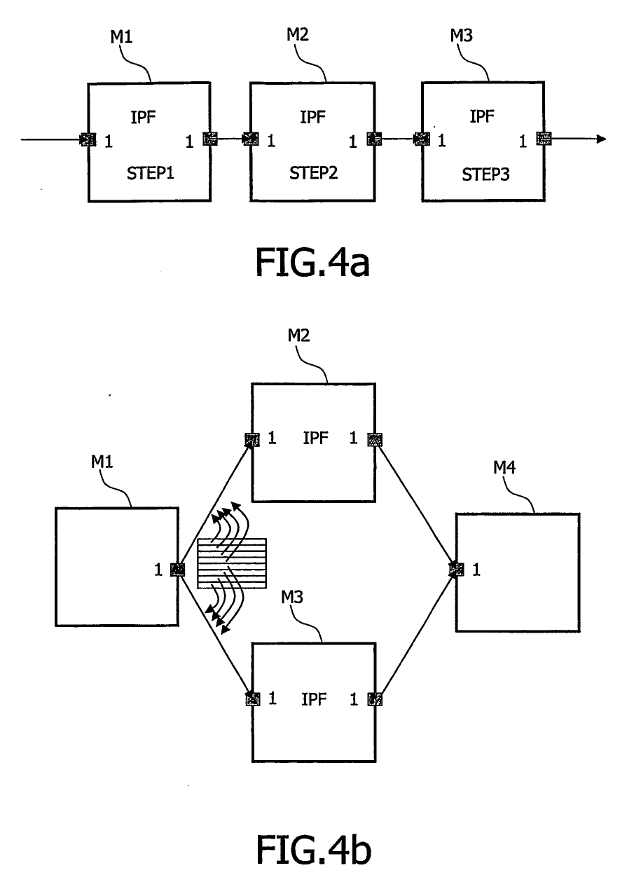

FIGS. 3b, 4a and 4b are examples of input documents in accordance with the invention which define applications involving different types of connections:
in the example of FIG. 3b, the input links L_{11,21} and L_{12,31} provide a broadcasting connection, i. e. the same image strips of the input image I are sent over two different data paths,
FIG. 4a presents three modules M₁, M₂ and M₃ linked by a pipeline connection, i. e. each module applies a different step STP₁, STP₂, STP₃ of an image processing function IPF to a received image strip,
FIG. 4b presents an application comprising a scatter/gather connection, i. e. a module M₁ scatters into two subsets of image strips. A first subset is processed by a module M₂, a second subset by the module M₃. Both modules M₂ and M₃ apply the same image processing function but to distinct subsets of image strips. The processed subsets are further gathered by the module M₄. It should be noted that the application is completely specified because the path followed by an image strip in the input document is fully determined by the geometry and the law associated with each input/output port.

In the case of a scatter/gather connection, there are several ways of distributing the image strips over a plurality of modules applying a same image processing function to different subsets of image strips of an input image I. Such a distribution is defined by the laws of the input nodes of the modules involved in the scatter/gather connection.

In a first embodiment of the invention, depicted in FIG. 4b, the image strips are simply divided into two subsets of consecutive image strips. The input ports of modules M₂ and M₃ have the following laws:

$${IF}_{2 , 1} = ( k \% \frac{S}{2} ) ,$$

where a % b is the rest of the integer division of a by b,

$${IF}_{3 , 1} = \frac{S}{2} + ( k \% \frac{S}{2} ) , where S = \overline{{S}_{m , p}}$$

is the total number of image strips in the input image I, if we assume that all the geometries defined by the modules forming the scatter/gather connection have the same total number of image strips.

An advantage of this first embodiment of the invention is that it is simple and well adapted to spatial filtering with a large overlap, because consecutive image strips are processed by a same module.

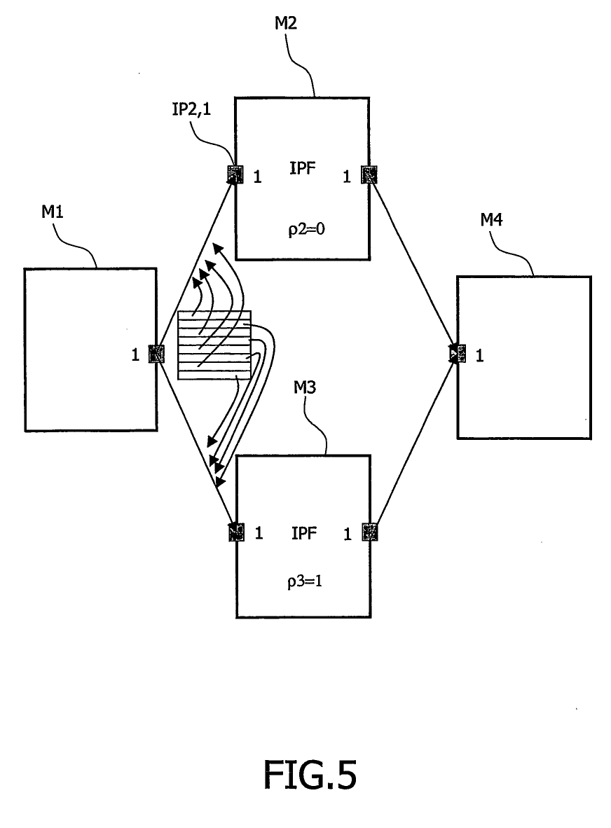

In a second embodiment of the invention presented in FIG. 5, the distribution of the image strips between the modules involved in the scatter/gather connection scheme is performed in an ordered and periodic manner. In this case, the laws of the modules M₂ and M₃ are parametrized by a rank and a period, said rank being the image strip index of a first image strip and said period being a difference between the indices of two consecutive image strips to be transmitted through said input/output port:
IF_{2,1}=(ρ₂+k.θ)% S, where θ is an integer equal to the number of modules involved in the scatter/gather connection and ρ₂ a rank of the module M₂ in the scatter/gather connection scheme,
IF_{3,1}=(ρ₃+k.θ)% S, where ρ₃ is a rank of the module M₃ in the scatter/gather connection scheme.

The first image strip IS₁ of an image is sent to the first module M₂, which has a rank ρ₂ equal to 0, the second image strip IS₂ is sent to the second module M₃ and has a rank ρ₃ equal to 1, the θ^{th} image strip is sent to the first module M₂ and has a rank equal to 0, etc.

In the simple case shown in FIG. 5, where the scatter/gather connection scheme comprises only two modules, the period of the distribution is θ=2 and the module M₂, which has the rank ρ₂=0, always processes the even image strips whereas the module M₃, which has the rank ρ₃=1, always processes the odd image strips.

In a more general scatter/gather connection scheme comprising θ modules, where θ is an integer greater than 2, each module Mₘ has a rank ρₘ and an input port IP_{m,p} driven by the following law: IF_{m,p}=(ρₘ+k.θ)% S. Therefore a module Mₘ always processes the same indices as specified by the law of its input ports .

It should be noted that if the period θ is a divider of the total number of image strips, then the set of image strips forming the input image can be divided into an integer number of periods. In this case, the image strips are evenly distributed among the modules involved, and all the modules of the group of modules forming the scatter/gather connection can process a same number of image strips.

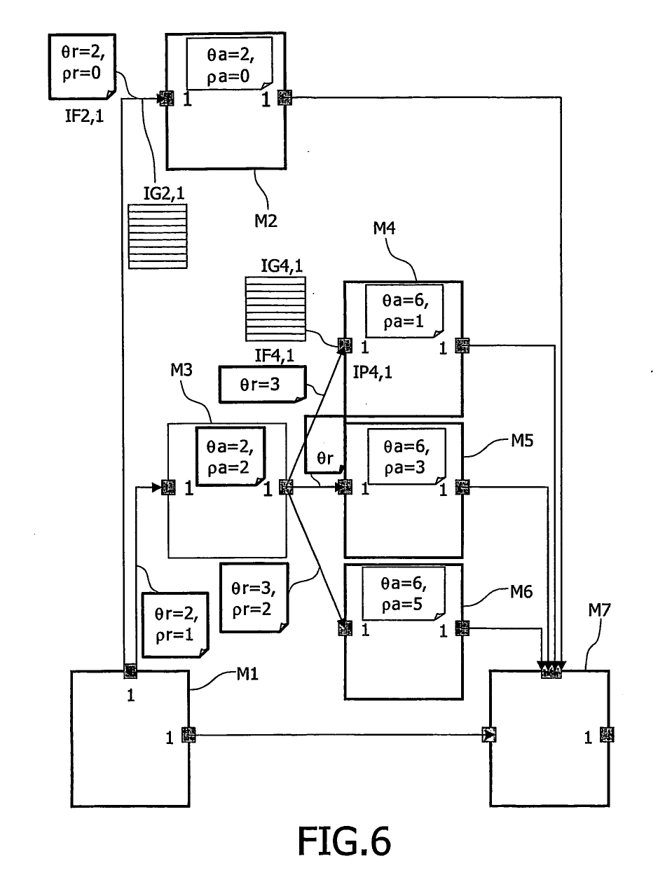

FIG. 6 is an example of an input document describing a more complex connection scheme in which seven modules are involved.

It should be noted that a graphical input document ID is built up using a graphical interface comprising predefined graphical elements, for instance available in a graphical library. A predefined graphical element, such as a box for a module M or a line for a link L comprises technical characteristics which are converted by the system into script instructions. The geometry IG_{1,1} and law IF_{1,1} attached, for example, to the input port IP_{1,1} of the module M₁ are also specified in the input document using predefined graphical elements. The predefined element used for defining the geometry IG_{1,1} is, for example, a two-dimensional array representing the input image, inside which it is possible to delimit consecutive image strips. The system in accordance with the invention is capable of converting such a graphical division of the two-dimensional array into a script describing the geometry IG_{1,1}. It should be noted that the two-dimensional array may advantageously be presented in the graphical interface as a pop-up window when clicking on the item IG_{1,1}.

The law IF_{1,1} is usually defined by a number of parameters relative to the module. Considering, for example, the second embodiment of the invention, a couple of parameters (θᵣ, ρᵣ) has to be specified.

In the input document in accordance with the invention, the application developer must also define an overlap Ov needed by a module Mₘ for applying an image processing function IPF to a current image strip s. Said overlap of a given strip represents a number of pixels contained in other image strips that have to be made available for processing the current image strip at the module Mₘ level. For example, the overlap Ov is equal to one when only the previous line is needed for processing the current image strip. The previous image strips may be needed in processed or unprocessed form. In either case, they can be stored in a memory at the module level.

Another option is to introduce the notions of regular, processed and transferred strips, which are defined below:
regular strips are non-overlapping image strips defined by the geometries of the input/output ports,
processed strips are the strips delivered by the image processing functions of the modules,
transferred strips are augmented versions of the regular strips taking into account spatial strip overlaps needed by an image processing function and specified by a law at the input port of the module Mₘ.

Summarizing, the system in accordance with the invention is capable of generating a distributed image processing application on the basis on an input document ID specifying at least the following elements:
a group of modules M₁ to M_{M},
Input and output links for linking the module Mₘ, where 1≦M, to other modules of the group,
Each module Mₘ being specified by an image processing function IPF, involving a relative overlap Ov, a processor PSₓ in charge of running the image processing function IPF, a number of input/output ports, to which are attached a geometry and a law, a type of data and module relative parameters such as, for example, a couple of relative period and rank.

The input document of the system in accordance with the invention specifies a number of parameters which are relative to a specific module or a group of modules, such as, for example, the period, the rank or the overlap. These parameters are defined in the input document ID for a module or a group of modules.

Advantageously, the system in accordance with the invention comprises calculating means for calculating absolute parameters corresponding to said relative parameters. In particular, said calculating means replace a relative rank ρᵣ and a relative period θᵣ of a module M within a group of modules forming a scatter/gather connection with an absolute rank ρₐ and an absolute period θₐ, which cumulates potential cascaded scatter/gather schemes. Said calculating means are also in charge of cumulating the relative overlaps of consecutive modules.

Referring to FIG. 6, relative periods and ranks (θᵣ, ρᵣ) are indicated at the link level, whereas absolute periods and ranks (θₐ, ρₐ) are indicated inside the modules.

The reading means 1 of the system in accordance with the invention are intended to interpret the input document ID. In particular, from the specification provided by the input document ID, the reading means 1 output a prototype of the image processing function IPF to be applied to the input image I by the module Mₘ. A source code corresponding to said prototype is further provided, for example, by the application developer or by a library of preprogrammed IP functions.

The compiling means 2 further check whether there are inconsistencies in the input document. The compiling means 2 are intended to check a syntax of the input document and a validity of the distribution described by the input document. For example, the compiling means 2 check that the scatter/gather connections specified in the input document ID are valid.

The building means 3 are further in charge of building an executable code from said compiled input document. Said executable code comprises instructions for driving the set of processors and makes them execute the image processing application as specified by the input document.

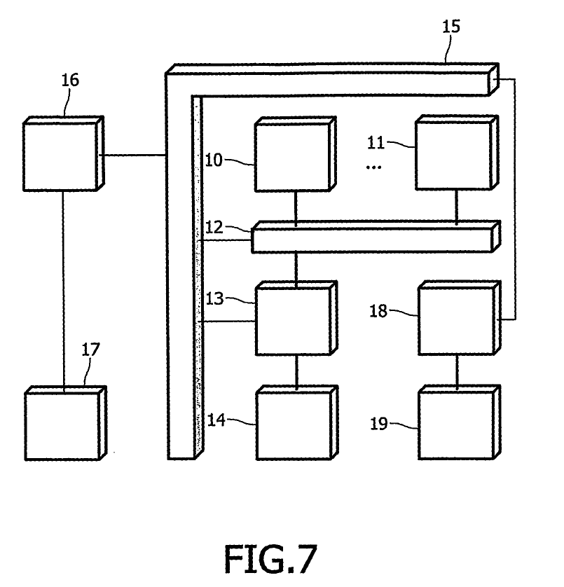

FIG. 7 shows a hardware platform comprising a system in accordance with the invention. The hardware platform comprises a set of processors 10, 11 which directly communicate with each other via a local bus 12. The local bus 12 is further connected to an input interface board 13 which is connected to peripheral hardware elements such as an X-ray detector 14.

The system in accordance with the invention is implemented, for example, by a host processor 16. The host processor 16 is connected to a terminal 17 for user interaction with the system. For example, the terminal 17 is used by the application developer for designing the input document ID. As a response, the system in accordance with the invention sends error messages output by the compiling means to the terminal 17. The host processor 16 is further connected to a control bus 15 which communicates with the set of processors 10,11 via the local bus 12, with the input interface board, and with an output interface board 18 associated with a hardware peripheral element such as a display unit 19. The executable code EC produced by the system in accordance with the invention is thus transmitted to the set of processors 10, 11 via the control bus 15 and the local bus 12.

The invention also related to a method of distributing an image processing application over a set of processors. Said method comprises the steps of:
reading an input document, said input document being designed for describing a distribution of an image processing application over said set of processors and comprising at least a module describing at least part of an image processing function to be applied to at least one input image by a processor of said set of processors, said input image being divided into image strips, said module comprising at least one input port for receiving image strips to be processed by said module via at least one input link and/or at least one output port for transmitting processed image strips over at least one output link, said input/output port being specified by a geometry and a law, said geometry defining a subdivision of said input image into a set of image strips and said law defining a subset of said set of image strips that is to pass through said input/output port,
compiling said input document for detecting inconsistencies in said input document,
building an executable code from said compiled input document for programming said set of processors.

The drawings and their description hereinbefore illustrate rather than limit the invention. It will be evident that there are numerous alternatives which fall within the scope of the appended claims. In this respect the following closing remarks are made: there are numerous ways of implementing functions by means of items of hardware or software, or both. In this respect, the drawings are very diagrammatic, each representing only one possible embodiment of the invention. Thus, although a drawing may show different functions as different blocks, this by no means excludes that a single item of hardware or software carries out several functions, nor does it exclude that a single function is carried out by an assembly of items of hardware or software, or both.

Any reference sign in a claim should not be construed as limiting the claim. Use of the verb “to comprise” and its conjugations does not exclude the presence of elements or steps other than those stated in a claim. Use of the article “a” or “an” preceding an element or step does not exclude the presence of a plurality of such elements or steps.

1. A system for generating an executable code to be executed by a set of processors, said system comprising:
reading means for reading an input document for describing a distribution of an image processing application over said set of processors, said input document comprising at least a module describing at least part of an image processing function to be applied to at least one input image by a processor of said set of processors, said input image being subdivided into image strips, said module comprising at least one input port for receiving image strips to be processed by said module via at least one input link and/or at least one output port for transmitting processed image strips over at least one output link, said input/output port being specified by a geometry and a law, said geometry defining a division of said input image into a set of image strips and said law defining a subset of said set of image strips that is to pass through said input/output port,
compiling means for detecting inconsistencies in said input document,
building means for building an executable code from said compiled document for programming said set of processors.

2. A system as claimed in claim 1, wherein said compiling means are designed to check a syntax of said input document and a validity of said distribution.

3. A system as claimed in claim 1, wherein said geometry locates an image strip by means of an image strip index, and said law defines said image strip index as a function of an iteration index.

4. A system as claimed in claim 1, wherein said geometry and said law are parametrized by parameters specified by said input document, said parameters being relative to a module.

5. A system as claimed in claim 3, comprising calculating means for converting relative parameters into absolute parameters with respect to said distribution.

6. A system as claimed in claim 3, wherein said law is parametrized by a rank and a period, said rank being the image strip index of a first image strip and said period being a difference between the indices of two consecutive image strips to be transmitted through said input/output port.

7. A system as claimed in claim 1, wherein said input document has a graphical format.

8. An input document for describing a distribution of an image processing application over said set of processors, said input document comprising at least a module describing at least part of an image processing function to be applied to at least one input image by a processor of said set of processors, said input image being divided into image strips, said module comprising at least one input port for receiving image strips to be processed by said module via at least one input link and/or at least one output port for transmitting processed image strips over at least one output link, said input/output port being specified by a geometry and a law, said geometry defining a subdivision of said input image into a set of image strips and said law defining a subset of said set of image strips that is to pass through said input/output port

9. A method of distributing an image processing application over a set of processors, said method comprising the steps of:
reading an input document, said input document being designed for describing a distribution of an image processing application over said set of processors and comprising at least a module describing at least part of an image processing function to be applied to at least one input image by a processor of said set of processors, said input image being divided into image strips, said module comprising at least one input port for receiving image strips to be processed by said module via at least one input link and/or at least one output port for transmitting processed image strips over at least one output link, said input/output port being specified by a geometry and a law, said geometry defining a subdivision of said input image into a set of image strips and said law defining a subset of said set of image strips that is to pass through said input/output port,
compiling said input document for detecting inconsistencies in said input document,
building an executable code from said compiled input document for programming said set of processors.

10. An executable code comprising a set of instructions which, when loaded into a set of processors, causes the set of processors to carry out the image processing application specified by the input document as claimed in claim 7.

11. A computer program comprising a set of instructions which, when loaded into a host processor, causes said host processor to carry out the method as claimed in claim 9.
